(19) United States
(12) Patent Application Publication
(10) Pub. No.: US 2024/0092349 A1
(43) Pub. Date: Mar. 21, 2024

(54) METHOD FOR DETERMINING THE POSITION AND ORIENTATION OF A VEHICLE WITHIN A RETRIEVAL POSITION WHICH IS ENCOMPASSED BY A PARKING AREA

(71) Applicant: Robert Bosch GmbH, Stuttgart (DE)

(72) Inventors: Rolf Nicodemus, Bietigheim-Bissingen (DE); Stefan Nordbruch, Leonberg (DE)

(21) Appl. No.: 18/546,475

(22) PCT Filed: Mar. 10, 2022
(86) PCT No.: PCT/EP2022/056211

§ 371 Date: Aug. 15, 2023

(30) Foreign Application Priority Data
Mar. 29, 2021 (DE) 10 2021 203 107.2

(51) Int. Cl. B60W 30/06; G06Q 10/02

(52) U.S. Cl. CPC B60W 30/06; G06Q 10/02; B60W 2540/049; B60W 2554/801; B60W 2556/45

(57) ABSTRACT

A method for determining the position and orientation of a vehicle within a retrieval position which is encompassed by a parking area and at which the vehicle is to be retrieved after an automatic parking process. The position and orientation of the vehicle within the retrieval position are determined on the basis of at least one specified comfort condition. In particular, the comfort condition comprises: —a minimum distance between one or more lateral surfaces or doors of the vehicle and one or more structural elements of the parking area and/or other vehicles and/or a lane and/or a pedestrian path; and/or—a specific orientation of the vehicle with respect to a lane direction. The vehicle is automatically provided in the specified position and orientation within the retrieval position.

### FIELD

The present invention relates to a method for determining a retrieval position for a vehicle, which retrieval position is encompassed by a parking area and at which the vehicle is to be retrieved after an automatic parking process. The present invention further relates to a corresponding terminal, a corresponding parking area server, a corresponding parking area, and a computer program.

### BACKGROUND INFORMATION

German Patent Application No. DE 10 2019 121 199 A1 describes a vehicle controller and a computer-readable recording medium for controlling a vehicle.

U.S. Patent Application Publication No. US 2020/0207335 A1 describes a method for operating a vehicle, and a computer program.

German Patent Application No. DE 10 2012 222 562 A1 describes a system for managed parking spaces for transferring a vehicle from a start position to a target position.

In the case of fully automated (autonomous) so-called valet parking, a vehicle is parked by its driver at a drop-off point, for example in front of a parking garage, and the vehicle itself drives from there into a parking position/parking bay and from there into a retrieval position, where the driver can retrieve his vehicle again after the end of the parking time.

Parking areas can have multiple exits, for example. In such a case, for example, each of the exits can be assigned one or more retrieval points or retrieval positions at which the vehicle is to be retrieved by the driver after fully automated valet parking is carried out.

### SUMMARY

An object of the present invention is to provide for efficiently determining a position and orientation of a vehicle within a retrieval position for a vehicle, which retrieval position is encompassed by a parking area and at which the vehicle is to be retrieved after an automatic parking process.

This object may be achieved by means of features of the present invention. Advantageous embodiments of the present invention are disclosed herein.

One aspect of the present invention relates to a method for determining a position and orientation of a vehicle within a retrieval position which is encompassed by a parking area and at which the vehicle is to be retrieved after an automatic parking process. According to an example embodiment of the present invention, the position and orientation of the vehicle within the retrieval position are determined on the basis of at least one specified comfort condition. In particular, the comfort condition in this case comprises:
a minimum distance between one or more lateral surfaces or doors of the vehicle and one or more structural elements of the parking area and/or other vehicles and/or a lane and/or a pedestrian path;

and/or
a specific orientation of the vehicle with respect to a lane direction.

According to the present invention, the vehicle is automatically provided in the determined position and orientation within the retrieval position.

According to the present invention, doors of the vehicle are to be understood as the side doors of a motor vehicle, and/or a trunk door or tailgate, and/or an engine hood, and/or a door to a load bed of the vehicle.

A lane direction is to be understood to mean, in particular, an intended direction of travel of the vehicle on a lane of the parking area, for example a lane leading to an exit of the parking area.

In a preferred embodiment of the present invention, the parking area comprises multiple different retrieval positions. At least one of the retrieval positions at which the vehicle of the user is to be retrieved after an automatic parking process is selected on the basis of the at least one specified comfort condition, and a position and orientation of the vehicle within the selected retrieval position is determined on the basis of the at least one specified comfort condition.

In particular, this may achieve the technical advantage that the process of a driver or user retrieving the vehicle can take place particularly efficiently.

In a particularly preferred embodiment of the present invention, at least two retrieval positions are selected, and a position and orientation of the vehicle within the selected retrieval positions are determined in each case. The vehicle can then be automatically reparked between the at least two selected retrieval positions during the retrieval process.

As a result, even apparently contradictory comfort conditions can advantageously be met.

Alternatively or additionally, according to an example embodiment of the present invention, at least two different positions and/or orientations of the vehicle within a selected retrieval position, which correspond to different comfort conditions, for example, can be determined within the selected retrieval position. The vehicle can be automatically reparked between these different positions and/or orientations of the vehicle within the selected retrieval position during the retrieval process.

As a result, multiple, even apparently contradictory comfort conditions can advantageously be met.

According to an example embodiment of the present invention, the comfort condition or the comfort conditions can preferably be specified by a user of the vehicle during a reservation of a parking position encompassed by the parking area. For this purpose, the user can explicitly specify a comfort condition, such as a defined minimum distance between one or more lateral surfaces or doors of the vehicle and one or more structural elements of the parking area and/or other vehicles and/or a lane and/or a pedestrian path, and/or a specific orientation of the vehicle. Alternatively or additionally, the user can specify a specific process to be carried out during the retrieval of the vehicle, in particular loading of the trunk of the vehicle and/or passengers getting in and/or driving off in a specific direction.

In a preferred embodiment of the present invention, one or more retrieval positions for which the comfort conditions can be met are suggested to the user for selection. The user can then decide at which of the retrieval positions the vehicle is to be provided. Alternatively, an automatic selection can also take place.

Particularly preferably, according to an example embodiment of the present invention, a retrieval position and/or a position and orientation of the vehicle within the retrieval position is also suggested or selected on the basis of
a current traffic situation within the parking area (401), and/or
experiences from the previous bookings and/or retrievals of the user, and/or
a number of known and/or ascertained passengers of the vehicle, and/or
analyses of the passenger(s), in particular carried objects.

According to a further aspect of the present invention, a terminal is proposed for specifying comfort conditions for a process of retrieving a vehicle parked automatically in a parking area. According to an example embodiment of the present invention, the terminal includes:
a first detection device for detecting at least one comfort condition for the retrieval process, wherein a comfort condition in particular comprises:
   a minimum distance between one or more lateral surfaces of the vehicle and one or more structural elements of the parking area and/or other vehicles and/or a lane and/or a pedestrian path, and/or
   a specific orientation of the vehicle with respect to an exit direction;

For this purpose, the terminal can specify, for example, a list of possible comfort conditions from which a user can select one or more comfort conditions.

According to an example embodiment of the present invention, the terminal also comprises a communication interface for transmitting data, which in particular represent the detected comfort conditions, to a parking area server.

According to an example embodiment of the present invention, the terminal can preferably be designed to determine a position and orientation of the vehicle within a retrieval position on the basis of the detected comfort conditions and to send same by means of the communication interface via a communication network to a parking area server for operating a parking area, so that the parking area server can control the automatic parking process of the vehicle on the basis of the retrieval position and the determined position and orientation of the vehicle within a retrieval position. For this purpose, the terminal can have a corresponding determination device, for example.

This may achieve an advantage that the computing power of the terminal can be used efficiently to determine a position and orientation of the vehicle within a retrieval position on the basis of the detected comfort conditions, and can provide this information to a parking area server.

Preferably, according to an example embodiment of the present invention, the terminal is designed to offer at least one retrieval position for a vehicle for selection, which retrieval position is encompassed by a parking area and at which the vehicle is to be retrieved after an automatic parking process. For this purpose, the terminal can comprise a display device for displaying at least one retrieval position encompassed by the parking area, and a second detection device for detecting a selection request of a user of the vehicle for one of the displayed retrieval positions, and a determination device for determining the retrieval position of the multiple retrieval positions that corresponds to the detected selection request as the retrieval position at which the vehicle of the user is to be retrieved after an automatic parking process. In this case, the communication interface of the terminal is designed to transmit the determined retrieval position and one of the determined position and orientation of the vehicle within the selected retrieval position to the parking area server.

It is thus possible to efficiently detect, in particular if there are multiple available retrieval positions, the retrieval position at which the driver or user wishes to retrieve or take over a vehicle after completion of the parking time or upon request. The vehicle can then be guided automatically to this retrieval position, and positioned and oriented there according to the specified comfort conditions.

Particularly preferably, according to an example embodiment of the present invention, the terminal is configured to output to the user at least one suggestion for a retrieval position and/or a position and orientation of the vehicle within a retrieval position on the basis of
the current traffic situation within the parking area, and/or
experiences from the previous bookings and/or retrievals, and/or
the number of known and/or ascertained passengers of the vehicle, and/or
analyses of the passenger(s), in particular carried objects.

For this purpose, the terminal can receive and process current information from a management system of the parking area, for example. The information can relate, for example, to the current traffic situation within the parking area. Alternatively or additionally, the terminal can process information of earlier parking processes, for example, in order to make a prediction about a retrieval position and/or comfort condition preferred by the user. Alternatively or additionally, the terminal can process information from sensors, for example camera sensors, in order to determine, for example, how many passengers the vehicle is to pick up during the retrieval process, and whether the passengers are carrying luggage items and how many luggage items there are and/or how large the luggage items are. The sensors can be attached to the terminal and/or within the parking area.

According to a further aspect of the present invention, a parking area server for operating a parking area is provided. According to an example embodiment of the present invention, the parking area server includes:
a computing unit which is designed to carry out a method according to the present invention, and
a communication interface which is designed to receive data representing at least one comfort condition and/or data representing a position and orientation of a vehicle within a retrieval position encompassed by the parking area from a terminal, in particular a terminal designed as described above, via a communication network.

The parking area server is designed to control an automatic parking process for a vehicle on the basis of the determined position and orientation of the vehicle within a retrieval position.

According to an example embodiment of the present invention, a communication interface of the parking area server is in particular designed to send position data from multiple retrieval positions encompassed by the parking area via a communication network to a terminal of a user, so that the terminal can display the multiple retrieval positions on the basis of the position data.

According to a further aspect of the present invention, a parking area for vehicles is provided, which is designed in particular for carrying out automatic or automated parking processes (automated valet parking), comprising:
multiple retrieval positions at which a vehicle can be retrieved after an automatic parking process has been carried out, and
a parking area server designed according to the present invention.

According to a further aspect of the present invention, a computer program is provided, comprising program code for carrying out a method according to the present invention when the computer program is executed on a computer.

According to one embodiment of the present invention, the communication network comprises a mobile radio network and/or a WLAN network.

According to an example embodiment of the present invention, the communication interface can be designed, for example, for wireless communication and can send a selected retrieval position and/or the determined position and orientation of the vehicle within a retrieval position to the parking area server, in particular by means of wireless communication according to one or more of the communication standards WiFi, mobile radio (4G, 5G, 6G), Bluetooth, BLE or by means of another, for example proprietary, communication protocol.

In a further embodiment of the present invention, communication via the communication network is in encrypted form or is encrypted.

According to an example embodiment of the present invention, the terminal can be designed, for example, as a mobile terminal, in particular as a smartphone or tablet computer, on which in particular corresponding software (“app”) having the aforementioned functionalities is implemented. The terminal in particular has a display with a graphical user interface. A touch-sensitive surface of the display of the terminal (touchscreen), for example, or a specific region thereof determined by the app, can be used as the detection device. Graphical input means, for example in the form of symbols and/or a schematic representation of a map of the parking area, can be used, by means of which a user can input comfort conditions for a process of retrieving a vehicle parked automatically in a parking area.

According to one embodiment of the present invention, the vehicle is a motor vehicle. The motor vehicle is, for example, a passenger car or a truck. According to one embodiment, the motor vehicle is a two-wheeled motor vehicle, for example a motorcycle.

Technical functionalities of the method or of the terminal or of the parking area server result analogously from corresponding technical functionalities of the parking area server or of the terminal or of the method, and vice versa.

The terminal is designed, for example, to execute or carry out the method.

The wording “or” comprises in particular “and/or”.

Embodiments of the present invention are described in detail with reference to the figures.

The present invention is explained in more detail below using preferred exemplary embodiments.

In the following description of the exemplary embodiments of the present invention, identical elements are denoted by the same reference signs, and repeated description of these elements may be omitted if necessary. The figures show the subject matter of the present invention only schematically.

### BRIEF DESCRIPTION OF THE DRAWINGS

FIG. 1 shows a flowchart of a method for determining a position and orientation of a vehicle within a retrieval position encompassed by a parking area, according to an example embodiment of the present invention.

FIG. 2 shows a terminal, according to an example embodiment of the present invention.

FIG. 3 shows a parking area server, according to an example embodiment of the present invention.

FIG. 4 shows a parking area, according to an example embodiment of the present invention.

FIGS. 5A to 5F show different examples of the position and orientation of a vehicle within retrieval positions at which the vehicle of the user is to be retrieved after an automatic parking process, according to an example embodiment of the present invention.

### DETAILED DESCRIPTION OF EXAMPLE EMBODIMENTS

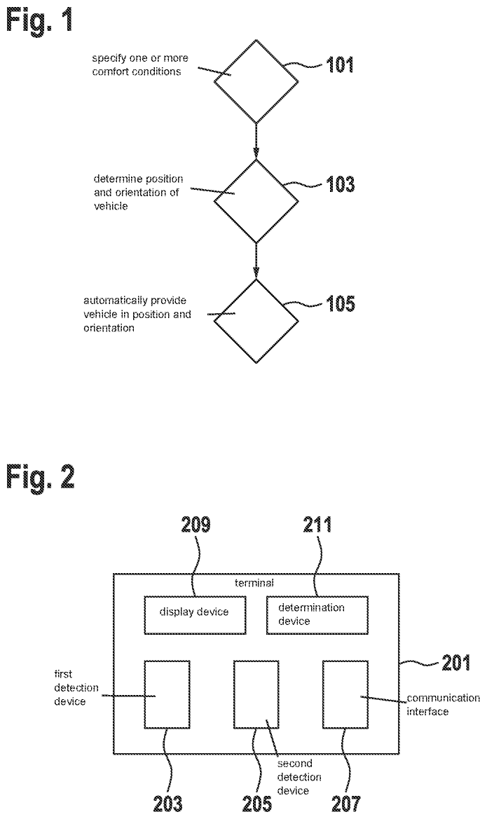

FIG. 1 shows a flowchart of a method for determining a position and orientation of a vehicle within a retrieval position which is encompassed by a parking area and at which the vehicle is to be retrieved after an automatic parking process.

The method comprises the following steps:
In a first step 101, one or more comfort conditions for the retrieval process of an automatic parking process are specified, wherein a comfort condition comprises in particular
   a minimum distance between one or more lateral surfaces or doors of the vehicle and one or more structural elements of the parking area and/or other vehicles and/or a lane and/or a pedestrian path and/or
   a specific orientation of the vehicle with respect to an exit direction.
In a second step 103, a position and orientation of the vehicle within a retrieval position encompassed by a parking area is determined such that the specified comfort conditions are met.
In a third step 105, the vehicle is automatically provided in the determined position and orientation within the retrieval position.

In one embodiment, the vehicle is guided from a parking position to the selected retrieval position driverlessly. Therefore, the user can thus retrieve or take over the vehicle at the retrieval position after an end of the automatic parking process.

Driverlessly means that there does not have to be a human driver in the vehicle in order to guide the vehicle.

The start of the automatic parking process therefore indicates the start of the driverless driving of the vehicle to the parking position. The end of the automatic parking process therefore indicates the time at which the vehicle has been parked in a retrieval position after it has been guided driverlessly from the parking position to the retrieval position.

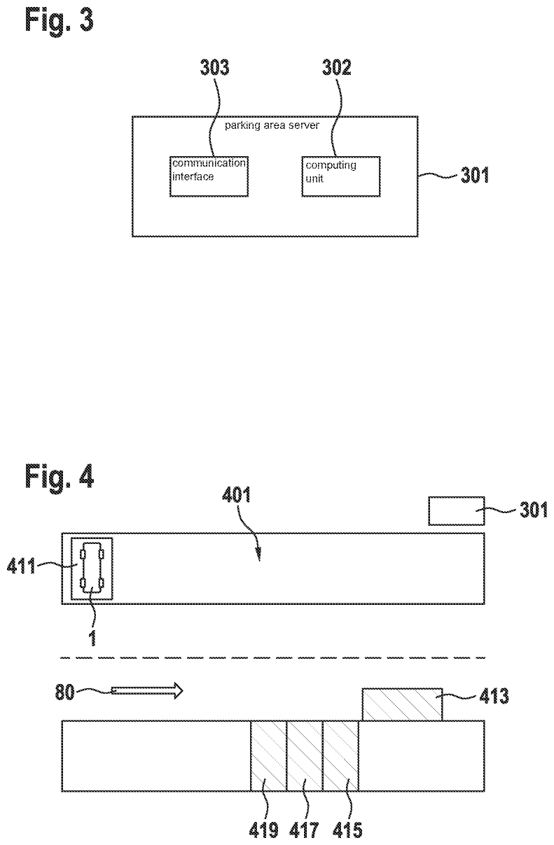

FIG. 2 shows a terminal 201 for specifying comfort conditions for a process of retrieving a vehicle parked automatically in a parking area.

The terminal 201 comprises a first detection device 203 for detecting at least one comfort condition for the retrieval process, wherein a comfort condition in particular comprises:
a minimum distance between one or more lateral surfaces of the vehicle 1 and one or more structural elements of the parking area and/or other vehicles and/or a lane and/or a pedestrian path, and/or
a specific orientation of the vehicle with respect to an exit direction.

The terminal also comprises a communication interface 207 for transmitting and receiving data to/from a parking area server.

The terminal 201 is designed to determine a position and orientation of the vehicle within a retrieval position on the basis of the detected comfort conditions and to send same by means of the communication interface 207 via a communication network to a parking area server for operating a parking area, so that the parking area server can control the automatic parking process of the vehicle on the basis of the retrieval position and the determined position and orientation of the vehicle within a retrieval position. Alternatively or additionally, the terminal 201 can be designed to send the comfort conditions by means of the communication interface 207 via the communication network to a parking area server for operating a parking area, so that the parking area server can determine a position and orientation of the vehicle within a retrieval position on the basis of the comfort conditions and can control the automatic parking process of the vehicle on the basis thereof.

The terminal 201 can also be configured to offer a user for selection at least one retrieval position, encompassed by a parking area, of multiple retrieval positions encompassed by the parking area, at which the vehicle is to be retrieved after an automatic parking process. For this purpose, the terminal can additionally have a display device 209 for displaying at least one retrieval position encompassed by the parking area, and
a second detection device 205 for detecting a selection request of a user of the vehicle for one of the displayed retrieval positions, and
a determination device 211 for determining the retrieval position of the multiple retrieval positions that corresponds to the detected selection request as the retrieval position at which the vehicle of the user is to be retrieved after an automatic parking process, and for determining a position and orientation of the vehicle within the selected retrieval position on the basis of the specified comfort conditions. The communication interface 207 can transmit the determined retrieval position and/or a position and orientation of the vehicle within the determined retrieval position to a parking area server.

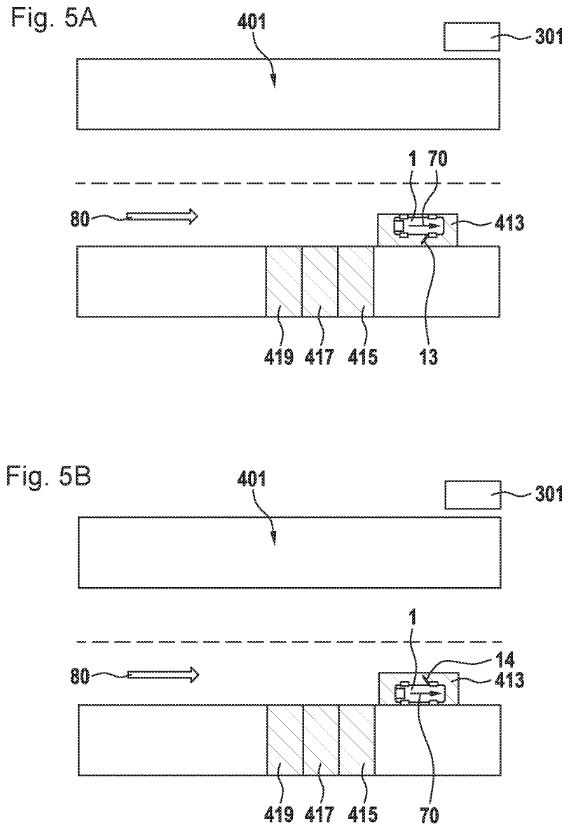

FIG. 3 shows a parking area server 301 for operating a parking area.

The parking area server 301 comprises a communication interface 303.

According to one embodiment, the parking area server 301 sends, by means of the communication interface 303 thereof, position data from multiple retrieval positions encompassed by the parking area via the communication network to the terminal 201. The terminal 201 comprises, for example, a communication interface (not shown here) which receives this position data. The terminal 201 then displays the retrieval positions by means of the display device 209 thereof on the basis of the received position data. The user selects one of the displayed retrieval positions. This selection request is detected by means of the detection device 205. The determination device 211 then evaluates the detected selection request and then determines the retrieval position of the multiple displayed retrieval positions at which the vehicle of the user is to be parked after an end of the automatic parking process as the retrieval position. This is based on the detected selection request.

This means therefore that the detection device 205 only detects the selection request of the user. For example, the detection device 205 detects touching of the display device 209 when the latter is designed as a touch-sensitive display device. For example, the detection device 205 detects an acoustic signal or an acoustic command, i.e., an acoustic selection request of the user. The determination device 211 then analyzes the acoustic signal of the user with regard to which of the retrieval positions the user has selected. In particular, the determination device 211 analyzes the detected touch with regard to which region of the display device the user has touched and thus which of the retrieval positions the user has selected.

The terminal 201 then sends this determined retrieval position back to the parking area server 301, which can thus efficiently control the automatic parking process for the vehicle 1 on the basis of the selected retrieval position.

Alternatively or additionally, the terminal 201 can receive data from the parking area server 301, for example, which characterize the parking area 401, so that the terminal 201 can carry out the calculations required for controlling the automatic parking process for the vehicle 1.

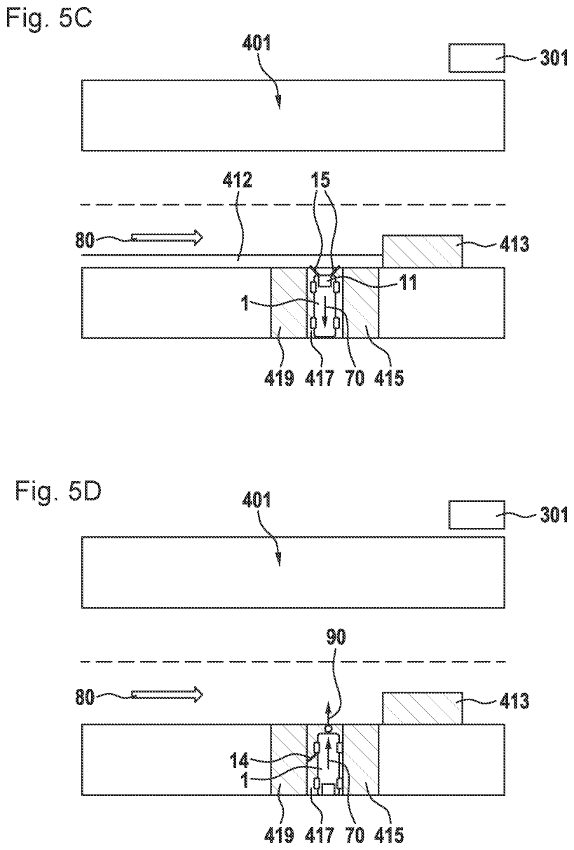

FIG. 4 shows a parking area 401 for vehicles, which is designed in particular for automated parking of the vehicles.

Multiple parking spaces or parking positions 411 are formed within the parking area 401, only one of which is shown for the sake of clarity. There are multiple retrieval positions 413, 415, 417, 419. A vehicle is to be parked at one of these retrieval positions 413, 415, 417, 419 after an automatic parking process so that a user can retrieve the vehicle 1. An automatic parking process will therefore end at one of these retrieval positions 413, 415, 417, 419. The vehicle 1 can be positioned differently within a selected retrieval position 413, 415, 417, 419, for example at a left-hand or right-hand edge of the relevant retrieval position 413, 415, 417, 419. The selection of the positioning of the vehicle 1 within a retrieval position 413, 415, 417, 419 takes place on the basis of at least one specified comfort condition. A comfort condition can comprise, for example, that a minimum distance is maintained between one or more lateral surfaces or doors of the vehicle 1 and one or more structural elements of the parking area 401 and/or other vehicles and/or a lane and/or a pedestrian path. This makes it possible, for example, to enter and/or load the vehicle 1 comfortably and safely. Furthermore, the vehicle 1 can be oriented differently with respect to a direction of travel. The selection of the orientation of the vehicle 1 within a retrieval position 413, 415, 417, 419 can also take place on the basis of at least one specified comfort condition. For example, a comfort condition can comprise that the vehicle 1 assumes a certain orientation with respect to an exit direction from the retrieval position, such that, for example, backing out is avoided.

The parking area 401 also comprises the parking area server 301 according to FIG. 3.

For example, the user specifies one or more comfort conditions by specifying a certain situation for the retrieval process. For example, the user can specify the number of passengers and/or the fact that the trunk of the vehicle must be accessible during the retrieval process so that it can be loaded. This results, for example, in certain prerequisites for minimum distances from the vehicle doors and/or certain orientations of the vehicle with respect to its direction of travel. These prerequisites can be defined as comfort conditions for the retrieval process.

In this example, the parking area comprises a plurality of retrieval positions 413, 415, 417, 419. For example, on the basis of the specified comfort conditions, the available retrieval positions 413, 415, 417, 419 for which the comfort conditions can be met are offered to a user on his mobile terminal, i.e., displayed on a screen (display device) of the terminal, for selection. The user selects one of these retrieval positions 413, 415, 417, 419 as the retrieval position at which the user wishes to retrieve his vehicle after the automatic parking process. The mobile terminal sends the selected, i.e., determined retrieval position to the parking area server 301. The parking area server 301 can then efficiently control the automatic parking process on the basis of the selected retrieval position or the selected retrieval positions.

In this sense, control can mean that the parking area server 301 controls and drives the vehicle 1 directly (in the sense of remote control), or that actuation data are transmitted to the vehicle 1, so that the vehicle 1 can itself, i.e., autonomously, drive to a target position according to the transmitted actuation data. Combinations of these two approaches are also possible.

For the performance of an automatic parking process, the user drives his vehicle 1 into the parking area 401 through an entrance (not shown) and parks his vehicle 1 at a drop-off position (not shown). He then leaves his vehicle 1. The vehicle 1 subsequently carries out an automatic parking process and thus parks automatically in one of the parking spaces 411. For example, the parking area server 301 controls the vehicle remotely and guides it driverlessly to the parking position. For example, the parking area server 301 sends the parking position to the vehicle 1, so that the vehicle 1 knows which of the parking positions it should drive to autonomously in order then to drive autonomously to the parking position.

After the end of a parking time, the vehicle 1 is guided driverlessly from the parking position to the selected retrieval position, so that the user can take over his vehicle at the selected retrieval position.

The present invention thus comprises in particular and inter alia the concept of providing a user, in particular a driver, with the possibility of specifying comfort conditions for the process of retrieving the vehicle 1 in parking areas, wherein an orientation and positioning of the vehicle within a retrieval position at which the user can retrieve or take over the vehicle is determined by the comfort conditions.

According to one embodiment, different retrieval positions, which can generally also be referred to in each case as a pickup zone, are displayed to the user, for example the driver. This takes place, for example, on the user's mobile terminal. The user, in particular the driver, then selects a desired retrieval position or a desired pickup zone. According to one embodiment, the display and selection can be carried out during a reservation before parking. According to one embodiment, the display and selection can in particular be carried out after a retrieval request (“retrieval command” by the user) has been received.

According to one embodiment, the user, in particular the driver, is informed of a route or a way to the selected retrieval position (pickup zone). This is done, for example, by means of the user's mobile terminal or by means of information in the parking area.

This in particular increases an acceptance of a user, in particular a driver, for such an automatic parking process. This therefore means that the user will preferably allow the automatic parking process to be carried out and will no longer drive the vehicle himself within the parking area. In general, an efficient operation of the parking area can be achieved thereby.

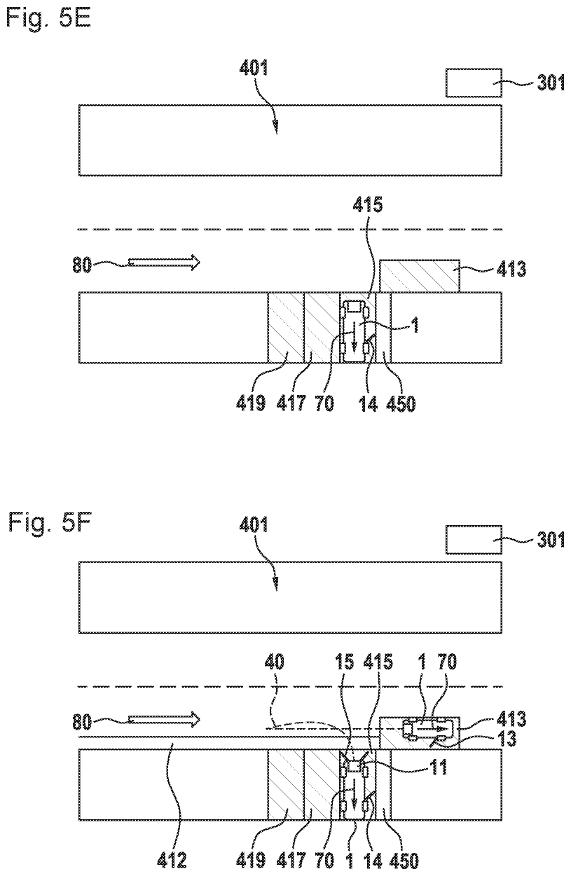

FIGS. 5A to 5F show various examples of a selection of a retrieval position and a position and orientation of a vehicle within a retrieval position on the basis of at least one comfort condition. These examples are not to be understood to be exhaustive; within the present invention, a plurality of further possible retrieval positions, and positions and orientations of a vehicle within the selected retrieval position, and combinations thereof are possible.

A vehicle 1 is located within the parking area 401, which is configured according to FIG. 4, for example, and also comprises the parking area server 301 according to FIG. 3. The vehicle was parked by means of an automated parking process on an allocated parking space (not shown). For example, after a specified parking time has elapsed or after a retrieval request by a user, the vehicle is guided automatically to one of the multiple retrieval positions of the parking area 401 and provided to the user there for takeover. According to the present invention, a position and orientation of the vehicle within the retrieval position 413, 415, 417, 419 is selected on the basis of at least one specified comfort condition.

In the example according to FIG. 5A, a vehicle 1 is parked at the retrieval position 413. The vehicle 1 is positioned within the retrieval position 413 such that it is parked so as to be offset to the left in the direction of the left-hand edge of the retrieval position 413 relative to a forward direction 70 or a longitudinal axis of the vehicle 1. Before the retrieval process, the comfort condition was set that a passenger can comfortably enter the vehicle 1 through the right-hand passenger door 13. This comfort condition is met by the position of the vehicle 1 at the left-hand edge of the retrieval position 413. In this example, the vehicle 1 is also oriented in such a way that, after assuming control of the vehicle 1, the driver can simply drive off forward in the lane direction 80 in which the exit of the parking area is located, in particular without having to carry out a pulling-out or turning maneuver. This can also be specified as a comfort condition.

In the example according to FIG. 5B, the vehicle 1 is parked at the retrieval position 413. The vehicle 1 is positioned within the retrieval position 413 such that it is parked so as to be offset to the right in the direction of the right-hand edge of the retrieval position 413 relative to the forward direction 70 or the longitudinal axis of the vehicle. The previously specified comfort condition is thus met in that a driver can comfortably enter the vehicle 1 through the left-hand driver door 14. In this example, the vehicle 1 is also oriented in such a way that, after assuming control of the vehicle 1, the driver can drive off forward in the direction 80 in which the exit of the parking area is located, for example, in particular without having to carry out a complicated pulling-out or turning maneuver.

In the example according to FIG. 5C, the vehicle 1 is parked at the retrieval position 417 transversely to the lane direction 80. The vehicle 1 is oriented within the retrieval position 417 such that the tail is pointing in the direction of the lane or a footpath. Furthermore, the vehicle 1 is arranged centrally in the retrieval position 417 with respect to its longitudinal axis. The previously specified comfort condition is thus met in that the vehicle 1 can be comfortably loaded via the trunk 11. The tailgates 15 of the vehicle 1 can be opened without protruding into the access 412 or blocking other retrieval positions 415, 419.

In the example according to FIG. 5D, the vehicle 1 is again parked at the retrieval position 417 transversely to the lane direction 80. The vehicle 1 is aligned within the retrieval position 413 such that the front of the vehicle 1 points in the direction of the lane. Furthermore, the vehicle 1 is arranged in the retrieval position 417 so as to be shifted to the right with respect to its longitudinal axis. The previously specified comfort condition is thus met in that a driver can comfortably enter the vehicle 1 through the left-hand driver door 14. In this example, the vehicle 1 is also oriented in such a way that, after assuming control of the vehicle 1, the driver can pull out forward in the direction 90 and simply keep moving in the lane direction 80, in particular without having to carry out a complicated pulling-out or turning maneuver.

In the example according to FIG. 5E, the vehicle 1 is parked at the retrieval position 415 transversely to the lane direction 80. In this example, the retrieval position 415 is delimited on one long side by a wall 450. The vehicle 1 is oriented within the retrieval position 415 such that the tail is pointing in the direction of the lane or a footpath. Furthermore, the vehicle 1 is arranged so as to be offset to the right (relative to the forward direction 70 of the vehicle 1) with respect to its longitudinal axis in the retrieval position 415. The previously specified comfort condition is thus met in that a driver can comfortably enter the vehicle 1 through the driver door 14, in that the driver door 14 can be opened as far as possible without hitting the wall 450.

In the example according to FIG. 5F, the vehicle 1 is initially parked at the retrieval position 415 transversely to the lane direction 80. The retrieval position 415 is again delimited on one long side by a wall 450. As in the previous example, the vehicle 1 is oriented within the retrieval position 415 such that the tail is pointing in the direction of the lane or a footpath. Furthermore, the vehicle 1 is arranged so as to be offset to the right (relative to the forward direction 70 of the vehicle 1) with respect to its longitudinal axis in the retrieval position 415. The previously specified comfort condition is thus met in that the vehicle 1 a driver can comfortably enter the vehicle 1 through the driver door 14, in that the driver door 14 can be opened as far as possible without hitting the wall 450. Furthermore, the vehicle is oriented such that the tail is pointing in the direction of the access 412. Thus, the tailgates 15 of the vehicle 1 can be opened and the trunk 11 of the vehicle 1 can be loaded comfortably. The tailgates 15 can also be opened upward (not shown here). It is also not shown here that it is also possible for only one tailgate to be present, which can be opened to the side and/or upward.

When the loading of the vehicle 1 is completed, and a driver or passenger has entered the vehicle 1 through the door 14 into the vehicle 1′, the vehicle in this example is guided automatically into a second retrieval position 413, for example along a trajectory 40 previously determined by the parking area server 301. In the second retrieval position 413, the vehicle is then positioned such that a second passenger can comfortably enter the vehicle through the door 13, in that the vehicle is arranged so as to be offset to the left relative to its forward direction 70 within the retrieval position 413. In this example, therefore, two retrieval positions 413, 415 are selected and a position and orientation of the vehicle 1 within each of the selected retrieval positions 413, 415 is determined separately for each of the retrieval locations 413 and 415, on the basis of comfort conditions which are different for each retrieval position 413, 415. The vehicle 1 is automatically reparked between the selected retrieval positions 413, 415 during the retrieval process.

This example thus offers the advantageous comfort aspect that different comfort conditions can be combined, so that initially incompatible comfort conditions can still be met by changing the retrieval position in the meantime. Thus, the vehicle 1 can initially be parked in such a way that the trunk can be reached comfortably. In a subsequent step, the vehicle can then be reparked automatically, for example at the request of the user or, if the system recognizes that the trunk and the door 14 are closed, in such a way that the driver and/or passenger can comfortably enter and can comfortably drive off, i.e., in particular without a pulling-out or turning maneuver.

In summary, features of the present invention include that an AVP vehicle can be provided for retrieval by the AVP infrastructure in such a way that it is comfortable for the driver and/or passengers.

1-16. (canceled)

17. A method for determining a position and orientation of a vehicle within a retrieval position which is encompassed by a parking area and at which the vehicle is to be retrieved after an automatic parking process, the method comprising the following steps:
determining the position and orientation of the vehicle within the retrieval position based on at least one specified comfort condition, wherein the at least one specified confort condition includes:
a minimum distance between one or more lateral surfaces or doors of the vehicle, and one or more structural elements of the parking area and/or other vehicles and/or a lane and/or a pedestrian path, and/or
a specific orientation of the vehicle with respect to a lane direction; and
automatically providing the vehicle in the determined position and orientation within the retrieval position.

18. The method according to claim 17, wherein the parking area includes multiple different retrieval positions, and at least one of the retrieval positions, at which the vehicle of a user is to be retrieved after an automatic parking process, is selected based on the at least one specified comfort condition, and a position and orientation of the vehicle within the selected retrieval position is determined.

19. The method according to claim 18, wherein at least two retrieval positions are selected and a position and orientation of the vehicle within each of the selected retrieval positions are determined, wherein the vehicle is automatically reparked between the selected retrieval positions during the retrieval process.

20. The method according to claim 18, wherein at least two different positions and/or orientations of the vehicle within a selected retrieval position are determined within the selected retrieval position, and wherein the vehicle is automatically reparked between the different positions and/or orientations of the vehicle within the selected retrieval position during the retrieval process.

21. The method according to claim 17, wherein the at least one comfort condition is specified during reservation of a parking position encompassed by the parking area, by a user of the vehicle, the user specifying a specific process which is to be carried out when the vehicle is retrieved including: i) loading of a trunk of the vehicle, and/or ii) passengers getting in, and/or iii) driving off in a certain direction.

22. The method according to claim 18, wherein one or more retrieval positions for which the at least one specified comfort condition can be met are suggested to a user for selection.

23. The method according to claim 18, wherein the retrieval position and/or a position and orientation of the vehicle within the retrieval position is suggested or selected based on:
a current traffic situation within the parking area, and/or
experiences from previous bookings and/or retrievals of the user, and/or
a number of known and/or ascertained passengers of the vehicle, and/or analyses of carried objects.

24. The method according to claim 23, wherein at least one suggestion is ascertained for the retrieval position and/or a position and orientation of the vehicle within the retrieval position, and is provided to a user.

25. A terminal configured to specify comfort conditions for a process of retrieving a vehicle parked automatically in a parking area, comprising:
a first detection device configured to detect at least one comfort condition for the retrieval process, wherein a comfort condition includes:
a minimum distance between one or more lateral surfaces or doors of the vehicle, and one or more structural elements of the parking area and/or other vehicles and/or a lane and/or a pedestrian path, and/or
a specific orientation of the vehicle with respect to a lane direction; and
a communication interface configured to transmit data which represent the detected comfort conditions, to a parking area server.

26. The terminal according to claim 25, wherein the terminal is configured to determine a position and orientation of the vehicle within a retrieval position based on the detected comfort conditions and to send the determined position and orientation using the communication interface via a communication network to a parking area server configured to operate the parking area, so that the parking area server can control the automatic parking process of the vehicle based on the retrieval position and the determined position and orientation of the vehicle within a retrieval position.

27. The terminal according to claim 25, wherein the terminal is configured to offer a user at least one retrieval position for the vehicle for selection, the retrieval position being encompassed by the parking area and at which the vehicle is to be retrieved after an automatic parking process, wherein the terminal includes:
a display device configured to display at least one retrieval position encompassed by the parking area,
a second detection device configured to detect a selection request of a user of the vehicle for one of the displayed multiple retrieval positions, and
a determination device configured to determine the retrieval position of the multiple retrieval positions that corresponds to the detected selection request as the retrieval position at which the vehicle of the user is to be retrieved after an automatic parking process, and to determine a position and orientation of the vehicle within the selected retrieval position based on the specified comfort conditions;
wherein the communication interface is configured to transmit the determined retrieval position and the determined position and orientation of the vehicle within the selected retrieval position to the parking area server.

28. The terminal according to claim 27, wherein the terminal is configured to output to a user at least one suggestion for a retrieval position and/or a position and orientation of the vehicle within the retrieval position based on:
a current traffic situation within the parking area, and/or
experiences from previous bookings and/or retrievals, and/or
a number of known and/or ascertained passengers of the vehicle, and/or
analyses of carried objects.

29. A parking area server configured to operate a parking area, comprising:
a computing unit configured to determine a position and orientation of a vehicle within a retrieval position which is encompassed by a parking area and at which the vehicle is to be retrieved after an automatic parking process, the computing unit configured to:
determine the position and orientation of the vehicle within the retrieval position based on at least one specified comfort condition, wherein the at least one specified comfort condition includes:
a minimum distance between one or more lateral surfaces or doors of the vehicle, and one or more structural elements of the parking area and/or other vehicles and/or a lane and/or a pedestrian path, and/or
a specific orientation of the vehicle with respect to a lane direction; and
automatically provide the vehicle in the determined position and orientation within the retrieval position; and
a communication interface configured to receive data representing the at least one comfort condition and/or data representing the position and orientation of the vehicle within a retrieval position encompassed by the parking area from a terminal of a user, via a communication network,
wherein the parking area server is configured to control an automatic parking process for the vehicle based on the determined position and orientation of the vehicle within the retrieval position.

30. The parking area server according to claim 29, wherein the communication interface configured to send position data from multiple retrieval positions encompassed by the parking area via the communication network to the terminal of the user, so that the terminal can display the multiple retrieval positions based on the position data.

31. A parking area for vehicles, comprising:
one or more retrieval positions at which a vehicle can be retrieved after an automatic parking process has been carried out; and
a parking area server configured to operate the parking area, the parking area server including:
a computing unit configured to determine a position and orientation of a vehicle within a retrieval position which is encompassed by a parking area and at which the vehicle is to be retrieved after an automatic parking process, the computing unit configured to:
determine the position and orientation of the vehicle within the retrieval position based on at least one specified comfort condition, wherein the at least one specified comfort condition includes:
a minimum distance between one or more lateral surfaces or doors of the vehicle, and one or more structural elements of the parking area and/or other vehicles and/or a lane and/or a pedestrian path, and/or
a specific orientation of the vehicle with respect to a lane direction; and
automatically provide the vehicle in the determined position and orientation within the retrieval position; and
a communication interface configured to receive data representing the at least one comfort condition and/or data representing the position and orientation of the vehicle within a retrieval position encompassed by the parking area from a terminal of a user, via a communication network;
wherein the parking area server is configured to control an automatic parking process for the vehicle based on the determined position and orientation of the vehicle within the retrieval position.

32. A non-transitory computer-readable medium on which is stored a computer program including program code for determining a position and orientation of a vehicle within a retrieval position which is encompassed by a parking area and at which the vehicle is to be retrieved after an automatic parking process, the program code, when executed by a computer, causing the computer to perform the following steps:
determining the position and orientation of the vehicle within the retrieval position based on at least one specified comfort condition, wherein the at least one specified confort condition includes:
a minimum distance between one or more lateral surfaces or doors of the vehicle, and one or more structural elements of the parking area and/or other vehicles and/or a lane and/or a pedestrian path, and/or
a specific orientation of the vehicle with respect to a lane direction; and
automatically providing the vehicle in the determined position and orientation within the retrieval position.
